(19) United States
(12) Patent Application Publication
(10) Pub. No.: US 2020/0201498 A1
(43) Pub. Date: Jun. 25, 2020

(54) DYNAMIC AUXILIARY USER INTERFACE

(71) Applicant: BBY SOLUTIONS, INC., Richfield, MN (US)

(72) Inventor: David Whelan, Seattle, WA (US)

(21) Appl. No.: 16/716,072

(22) Filed: Dec. 16, 2019

Related U.S. Application Data
(60) Provisional application No. 62/784,294, filed on Dec. 21, 2018.

(51) Int. Cl. G06F 3/0484; G06F 3/0483

(52) U.S. Cl. CPC G06F 3/0484; G06F 3/0483

(57) ABSTRACT

A primary user interface displays primary content from a primary-content source, reads user interaction with the primary content, and communicates with the primary-content source based on the user interaction. A dynamic auxiliary user interface includes an information display portion and a dynamic portion. The information display portion displays supplemental information, at least a part of which is dependent on the primary content. The dynamic portion generates or varies the display of the supplemental information in response to the primary content or an attribute of the primary content.

### PRIORITY CLAIM

This application claims the benefit of U.S. Provisional Application Ser. No. 62/784,294 filed Dec. 21, 2018, the disclosure of which is incorporated by reference herein in its entirety.

### TECHNICAL FIELD

Embodiments described herein generally relate to data-processing and, more particularly, to presentation processing of a document or application operator interface.

### SUMMARY

One aspect of the disclosure is directed to a primary user interface and a dynamic auxiliary user interface implemented on a computer system. The primary user interface is operative to display primary content from a primary-content source on the display device, read user interaction with the primary content via the user-input device, and communicate with the primary-content source via the communications device based on the user interaction. The dynamic auxiliary user interface includes an information display portion, a control portion, and a dynamic portion. The information display portion is operative to display supplemental information at least a part of which is dependent on the primary content, and to display a control element, wherein the supplemental information and the control element are viewable on the primary user interface. The control portion is operative to read user interaction with the control element via the user-input device and execute an action responsive to the user interaction with the control element. The dynamic portion is operative to autonomously generate or vary the display of the supplemental information in response to the primary content, an attribute of the primary content, or the user interaction with the control element.

In a related aspect, the information display portion is operative to display supplemental information to be viewable on the primary user interface, and including a first information portion and a second information portion, where the first information is received from a supplemental-information source that is a computing entity distinct from the user-interface apparatus, and where the second information portion is dependent on the primary content. The dynamic portion is operative to communicatively interact with the primary-content source to obtain additional supplemental information that is distinct from the primary content, and to generate or vary the display of the supplemental information, in response to the primary content or an attribute of the primary content.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is a block diagram illustrating a dynamic auxiliary user interface according to some aspects of the embodiments.

FIG. 2 is a diagram illustrating an example relationship between a primary user interface, and a dynamic auxiliary interface, and their respective sources of content, according to some embodiments.

FIG. 3 is a diagram illustrating a dynamic portion of the dynamic auxiliary interface of FIG. 1 according to an embodiment.

FIG. 4 is a structural diagram illustrating a sensor engine of a dynamic portion of the dynamic auxiliary interface of FIG. 1 according to an implementation.

FIG. 5 is a structural diagram illustrating a dynamic content engine of the dynamic portion pf FIG. 4 according to an implementation.

FIG. 6 is a block diagram illustrating a dynamic portion configurator graphical user interface (GUI) according to an example embodiment.

FIG. 7 is a block diagram illustrating a computer system in the form of a general-purpose machine, which may be incorporated as part of a stationary, mobile, or distributed-computing system.

FIG. 8 is a diagram illustrating an exemplary hardware and software architecture of a computer system such as the one depicted in FIG. 5, in which various interfaces between hardware components and software components are shown.

FIG. 9 is a block diagram illustrating processing devices according to some embodiments.

FIG. 10 is a block diagram illustrating example components of a CPU according to various embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Embodiments may be implemented as part of a data-processing and computing platform. The data-processing and computing platform may be one physical machine, or may be distributed among multiple physical machines, such as by role or function, or by process thread in the case of a cloud computing distributed model. In various embodiments, aspects of the invention may be configured to run in virtual machines that in turn are executed on one or more physical machines. It will be understood by persons of skill in the art that features of aspects of the present subject matter may be realized by a variety of different suitable machine implementations, which are transformed into special-purpose machines, or otherwise have their functionality or usability enhanced, by implementation of embodiments described herein.

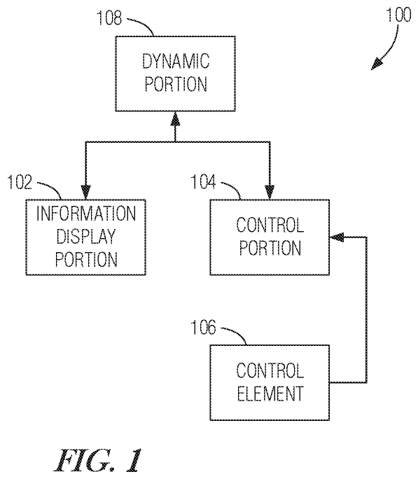

FIG. 1 is a block diagram illustrating dynamic auxiliary user interface 100 according to some aspects of the embodiments. Dynamic auxiliary user interface 100 is composed of a number of subsystems, components, circuits, modules, or engines, which for the sake of brevity and consistency are termed engines, although it will be understood that these terms may be used interchangeably. Engines are realized in hardware, or in hardware controlled by software or firmware. As such, engines are tangible entities that are specially structured and configured for performing specific operations.

In an example, circuitry may be arranged (e.g., internally or with respect to external entities such as other circuits) in a specified manner as an engine. In an example, one or more hardware-based processors, or a portion of such a processor, may be configured by firmware or software (e.g., executable instructions) as an engine that is operable to perform specific operations. In an example, the software may reside on a tangible machine-readable storage medium. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines comprise a general-purpose hardware processor core configured using software; the general-purpose hardware processor core may be configured as respective different engines at different times. Software may accordingly configure a hardware processor core, for example, to constitute a particular engine at one instance of time and to constitute a different engine at a different instance of time.

As illustrated, dynamic auxiliary user interface 100 may be implemented by a data-processing and computing platform, and includes information display portion 102 and control portion 104. Information display portion 102 is operable to present supplemental information (e.g., textual, graphical, or combined textual and graphical, information) for viewing by a human end-user.

Control portion 104 is to receive input originated by the end-user and to cause the data-processing and computing platform to execute one or more responsive actions based at least in part on that input. The input originated by the end-user may be via interaction with control element 106, such as a virtual button, slider, knob, text-input box, or the like, or any practical combination thereof. The one or more responsive actions may be further based on decision criteria, additional input, or sensed circumstances, monitored end-user actions, or the like. In some implementations, a responsive action to the input received via control element 106 includes exchanging information with back-end services that affect the information displayed on a primary user interface.

According to some embodiments, dynamic auxiliary user interface 100 includes one or more dynamic portions 108 that work to autonomously vary the information displayed as at least a part of the display portion. In related embodiments, the one or more dynamic portions 108 work to vary the one or more responsive actions of the control portion. Notably, dynamic auxiliary user interface 100, according to some embodiments, is added to, inserted in, overlaid, appended to, or otherwise incorporated, as part of a primary user interface.

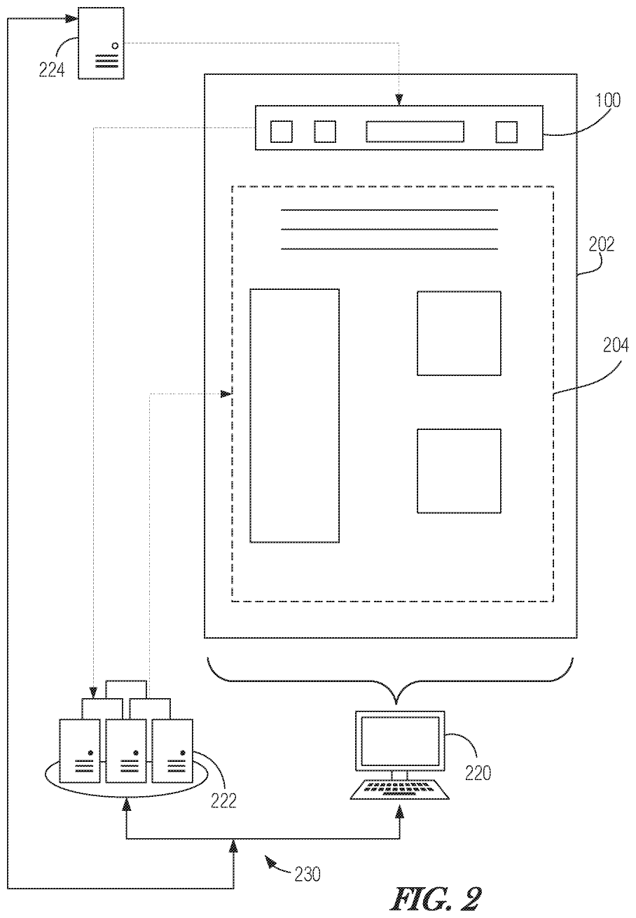

FIG. 2 is a diagram illustrating an example relationship between a primary user interface 202, dynamic auxiliary user interface 100, and their respective sources of content, according to some embodiments. Primary user interface 202 may include an application user interface (e.g., word processor, spreadsheet, computer-aided design (CAD) tool, image-processing application, game, or the like), or a Web page or a set of web pages that are part of one or more websites, as displayed and interactively controllable via a web-browser application running on a data-processing and computing platform.

As depicted, primary user interface 202 has its own primary content 204, which may include textual or graphical objects that are displayed, media content, user-interactive content such as applets, widgets, scripts, or the like, as well as links and various other user-input controls. Dynamic auxiliary user interface 100 is incorporated as part of primary user interface 202 to be displayed together with, or alongside, primary content 204.

Primary user interface 202 may be realized by operation of a local computing system 220 under software control. Local computing system 220 may be in the form of a personal computer, tablet, smartphone, game console, television, smart appliance, wearable device (e.g., smart watch, smart glasses, head-mounted display), or other suitable computing system with a display and user input device, various details of which are described subsequently in this disclosure. Primary content 204 may be originated by a primary-content source, which in some examples may be realized in the local computing system 220, or in a remote computing system 222.

Remote computing system 222 may be a Web server, cloud services provider, data center, or the like. Remote computing system 222 may also include back-end services. In the present context, back-end services are the parts of a computer system, application, or website, that are not directly accessed by the user, typically responsible for storing and manipulating data. For example, in an e-commerce scenario, the back-end services may include an inventory-management database, a transaction database used to implement a virtual shopping cart as seen from the primary user interface 202, a database containing user ratings, a database containing user-account information, or the like.

Dynamic auxiliary user interface 100 may also be realized by operation of local computing system 220 under software control, although portions of the code for realizing dynamic auxiliary user interface 100 and at least some of the supplemental information to be displayed by dynamic auxiliary user interface 100 may be provided by one or more sources distinct from local computing system 220 and remote computing system 222. In examples where at least some of dynamic auxiliary user interface 100 is generated by a remote computing entity from the one that displays the primary user interface, a communication channel is used to transmit the code representing the dynamic auxiliary user interface 100 from the remote computing entity to the computing entity on which the dynamic auxiliary user interface 100 is to be displayed (e.g., by local execution of the code) to appear with the primary user interface 202.

The supplemental information may include a portion that is originated by a supplemental-information source (e.g., separate remote computing system 224) that is distinct from the source of primary information 204 such as remote computing system 222. In related embodiments, different portions of the supplemental information may be originated in local computing system 220, remote computing system 222, or in separate remote computing system 224.

In various embodiments, remote computing system 222 and remote computing system 224 are distinct computing entities, such as distinct computer systems that may be geographically separated or operated by different users or business entities. In other examples, remote computing system 222 and remote computing system 224 may be distinct computing entities in the form of different virtual machines that are executed on the same computing platform. In still other examples, remote computing system 222 and remote computing system 224 may be distinct computing entities in the form of isolated processes that are running under distinct user privileges on a common computing platform.

Notably, with reference to FIGS. 1 and 2, according to aspects of the disclosed subject matter, portions of dynamic auxiliary user interface 100 may be independently managed (e.g., created, modified, stored) from primary content 204. Moreover, in related aspects, the dynamic portions 108 may operate to generate and vary the display of the supplemental information to enhance or otherwise depend on portions of primary content 204. For instance, in some examples, the supplemental information may be generated or varied in response to one or more portions of primary content 204. In other related aspects, dynamic portions 108 may even operate to dynamically affect primary content 204.

In related embodiments, one or more communication channels 230 are provided between local computing system 220, remote computing system 222, and separate remote computing system 224 to facilitate exchange of information between these computing entities. In some embodiments of this type, local computing system 220 receives the primary content 204 from remote computing system 222 to be displayed in primary user interface 202. Local computing system 220 may also receive the code to implement dynamic auxiliary user interface 100, along with certain textual, graphical, and dynamic objects, from remote computing system 224, via one or more communication channels 230.

In addition, while being executed on local computing system 220, dynamic auxiliary user interface 100 may read primary content 204 locally, and may request additional information (besides primary content 204) from remote computing system 222. While being executed, dynamic auxiliary user interface 100 may also request other additional information (e.g., additional textual, graphical, or dynamic objects) from remote computing system 224, in response to reading and processing primary content 204, received additional information from remote computing system 222, or a combination thereof. The additional information may be used by dynamic auxiliary user interface 100 to add to, or vary, the supplemental information for display via information display portion 102. Dynamic auxiliary user interface 100 may further interact with remote computing system 222 as the source of the primary content 204 to affect the information displayed as primary content 204, or to initiate or participate in an exchange or transaction associated with primary content 204.

As an example use-case embodiment, primary user interface 202 may be a web page, whereas dynamic auxiliary user interface 100 may be in the form of an advertisement banner. In related embodiments, primary user interface 202 may be included as part of one or more other applications, such as games, media players, utilities, productivity applications (such as word processing, spreadsheet, database-administration, presentation, image-editing), computer-aided design (CAD), shopping, research or reference, security, point-of-sale, kiosk, or any practical application, whereas dynamic auxiliary user interface 100 may be in the form of a tab, side-panel, pop-up window, separate window, menu, ribbon, tool palate, or the like. Notably, a document, such as a spreadsheet, when opened by a suitable application program, may constitute a primary user interface, such as when control elements (e.g., macros, code objects) are included as part of the document content. A primary user interface may constitute a combination that includes both, document(s), and application(s), as the example of a web page (e.g., the hypertext markup language (HTML) code, together with functionality of the web-browser application that reads and carries out the HTML code).

In a related aspect, primary user interface 202 presents a user-interactive process flow or workflow that may involve some sequence of standard user interactions in the course of facilitating a task or user objective. For example, in an e-commerce scenario, primary user interface 202 may present a hierarchical menu of items for sale, or a search-engine input that returns a result list of items for sale matching the search criteria. In response to user selection of a particular item, an item-details page may be presented from which a user may select the item for addition to a virtual shopping cart, which is generally a list of selected items for purchase associated with an account of the user or session.

In one aspect, dynamic auxiliary user interface 100 may include a set of dynamic portions 108 that facilitates an alternative process flow or workflow. For instance, an alternative process flow or workflow may constitute bypassing one or more of the standard user interactions of the primary user interface. In the e-commerce scenario, for instance, dynamic auxiliary user interface 100 may be a notification that includes in-stock information, product rating information, and an add-to-cart button, that facilitates user selection of the item for placement of that item in the shopping cart, thereby bypassing the usual shopping process facilitated by the workflow of primary user interface 202.

In a related aspect, dynamic portions 108 of dynamic auxiliary user interface 100 interact with back-end services that are associated with the primary user interface 202.

In one such embodiment, dynamic portion 108 obtains situational information from primary user interface 202, uses the situational information to determine the type of information to be displayed via information display portion 102, obtains specific details from the situational information, where applicable, to supplement or augment the information to be displayed, and receives and processes user input through one or more user-input-interactive active control elements.

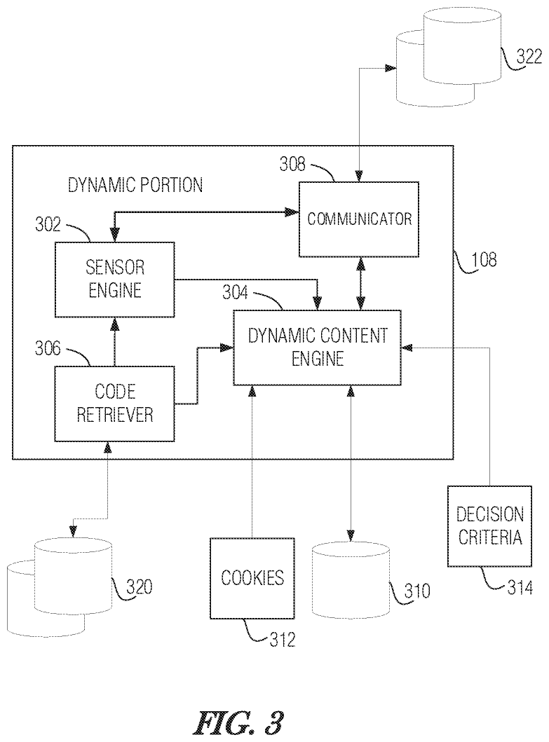

FIG. 3 is a diagram illustrating dynamic portion 108 in greater detail according to an embodiment. Dynamic portion 108 includes sensor engine 302 and dynamic content engine 304. Sensor engine 302 includes machine-executable code that, when executed, causes the data-processing and computing platform to read the content, or an attribute, of the primary user interface, and detect any configuration trigger that may be present among the content or attribute. Examples of content items or attributes that may constitute a configuration trigger include a particular uniform resource locator (URL), a specific portion of a URL one or more keywords, certain semantic content, an identifiable image or video clip, a SKU number or barcode image (e.g., 1-D barcode, QR-code), an object that is machine-recognizable from an image, certain code or comments included therein (e.g., html, Java), metadata content, or the like. In an e-commerce context, the configuration trigger may include an item name, terms appearing in an item description, manufacturer or brand name of an item, a model number, an image of an item, a URL associated with a product page for an item, etc.

Dynamic content engine 304 includes machine-executable code that, when executed, causes the data-processing and computing platform to select or generate content of the information display portion based on the detected configuration trigger. The selection or generation of the content of the information display portion is performed according to preconfigured content-selection or content-generation code of the dynamic content engine 304.

In related embodiments, the preconfigured content-selection or content-generation code of dynamic content engine 304 performs one or more actions such as initiating a query in one or more databases 310 (or, more generally, looking up information in a data structure), reading browser cookies 312, looking up decision criteria 314, or other operation that may involve accessing information from one or more sources other than the primary user interface 202.

In additional related embodiments, one or more of the dynamic portions 108 includes code retriever engine 306 that includes a link or pointer to one or more locations 320, such as remote computing system 224, which may provide additional machine-executable code of the sensor engine or dynamic content engine, or to additional data such as operational parameters relating to operation of dynamic portion 108. Code retriever engine may further include code to read that machine-executable code or additional data, and initiate its execution or utilization.

In further embodiments, one or more of the dynamic portions includes communicator 308 that includes machine-executable code that, when executed, causes the data-processing and computing platform to communicate with an external computing system, such as remote computing system 222 (which may include a Web server or back-end services corresponding to primary content 204). These communications may include requests for additional information, or requests to transact, for instance.

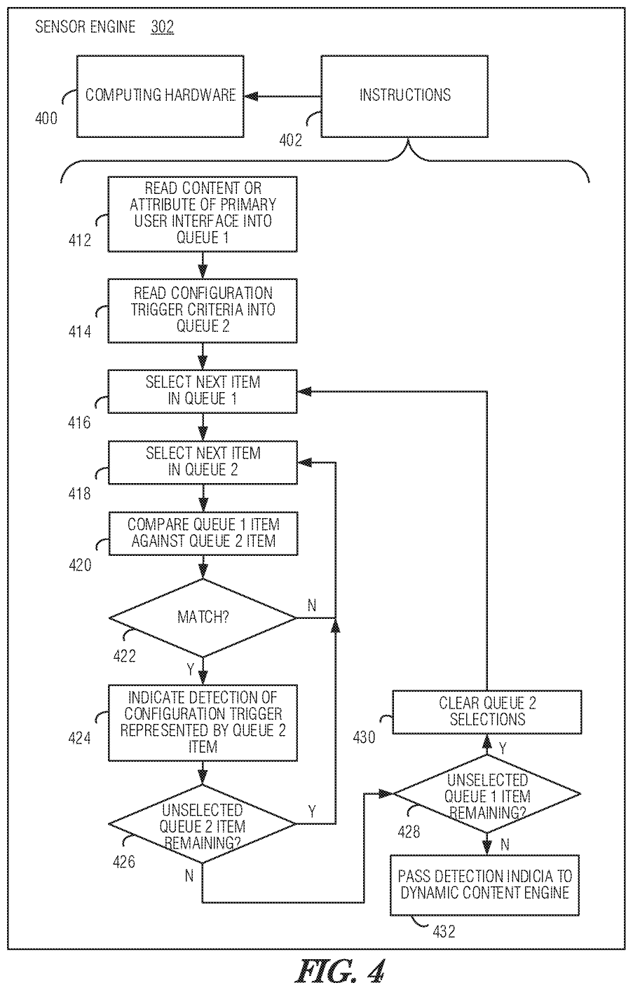

FIG. 4 is a structural diagram illustrating sensor engine 302 according to an implementation. As depicted, sensor engine 302 includes computing hardware 400, and instructions 402 stored on one or more non-transitory storage media and executable by computing hardware 400 to implement sensor engine 302 according to this example. As an implementation example, with reference to FIGS. 2 and 3, computing hardware 400 may include local computing system 220, and instructions 402 may be provided from one or more locations 320 by remote computing system 222, or separate remote computing system 224. Instructions 402, when executed, cause the computing hardware 400 to implement the following process, which may be performed with different orderings of operations unless certain operations are specifically called out as being performed in sequence. In some variations, certain operations may be modified or omitted.

At 412, sensor engine 302 reads the primary content 204, or an attribute (e.g., URL, filename, file path, metadata) of primary user interface 202. Various items of the content 204 or attribute(s) are saved as a list, queue, or other data structure (which, for the sake of brevity, is referred to hereinafter as queue 1). Items of content 204 may be extracted based on their position in a table, on tags associated with respective items, or on item-extraction criteria that may be included as part of instructions 402.

At 414, sensor engine 302 reads configuration trigger criteria (which may be included as part of instructions 402 or separately provided from a local or remote data store) into a second list, queue or data structure, e.g., queue 2. The configuration trigger criteria defines portions of content that constitute configuration triggers.

At 416 and 418 outer and inner loops are indexed for iteration. At 420, in each iteration, the current item of content 204 or attribute of the primary user interface in queue 1 is compared against the current criteria item in queue 2. At decision 422 a determination is made if there is a match (which may be an exact match or satisfaction of a defined similarity threshold) as a result of the comparison. In the negative case, the process loops back to 418 to select the next criteria item. In the positive case, the process advances to 424, where an indication of positive detection corresponding to the last comparison is provided. An output data structure may be built listing the indications of configuration trigger detections.

The iterations continue through the inner loop and outer loop as per decisions 426 and 428-430, respectively. At the conclusion of the iterations, the detection indicia as the output of the comparison operations is passed to dynamic content engine 304.

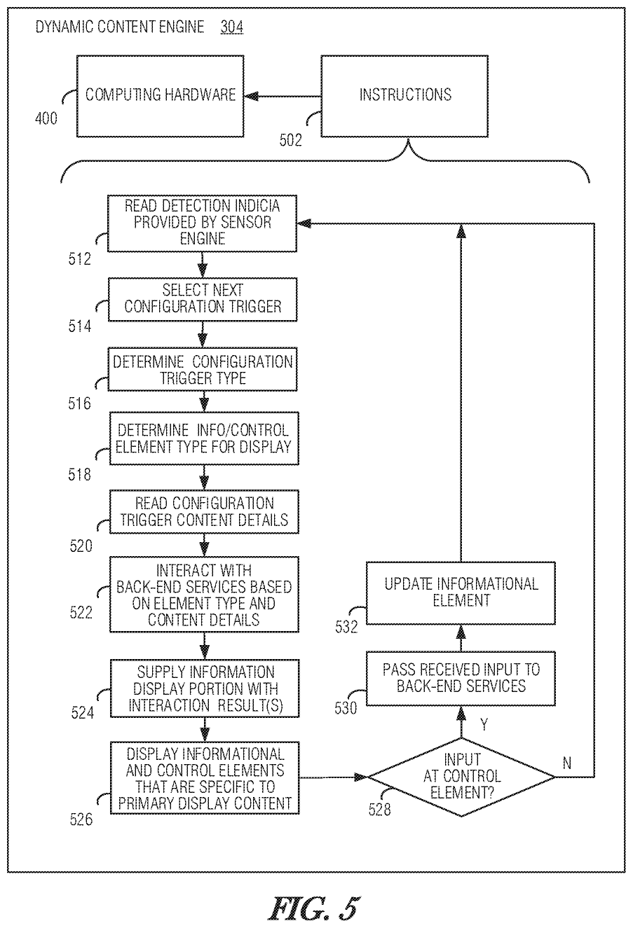

FIG. 5 is a structural diagram illustrating dynamic content engine 304 according to an implementation. As depicted, dynamic content engine 304 includes computing hardware 400, and instructions 502, which may be appended to instructions 402, and stored on the same one or more non-transitory storage media and executable by computing hardware 400, to implement dynamic content engine 304 according to this example. Instructions 502, when executed, cause the computing hardware 400 to implement the following process, which may be performed with different orderings of operations unless certain operations are specifically called out as being performed in sequence. In some variations, certain operations may be modified or omitted.

At 512, dynamic content engine 304 reads the detection indicia of the presence of one or more configuration triggers in primary content 204. At 514, an iterative loop is started with the selection of the next configuration trigger of the detected set. At 516 dynamic content engine 304 determines the type of the configuration trigger. Types of configuration triggers may include URLs, SKU numbers, model numbers, descriptions, image, etc.

At 518, dynamic content engine 304 determines a type of informational or control element to be displayed or embedded in dynamic auxiliary user interface 100 based on the configuration trigger type. At 520, the details of the configuration trigger content are read to automatically provide an input to the informational or control element. At 522, dynamic content engine 304 interacts with the back-end services based on the informational or control element type and the content details.

For instance, in response to a configuration trigger that is a SKU number (or other identifier of a purchasable item), a dynamic informational element type determined at 518 may be an indicator of available inventory of an item. The details of the configuration trigger, namely, the SKU number or other identifier, may be read as the input at 520 to query inventory information corresponding to that specific item.

In this example, a related control element may be further determined to be included in dynamic auxiliary user interface 100 at 518. For instance, the control element can be a text-entry or drop-down field to interactively accept user input specifying a store location, for which the available inventory indicator may be updated via back-end database query. Also, a control element, such as an “add to cart” button may be displayed in dynamic auxiliary user interface 100, with the button being configured with code to instruct back-end services to add the purchasable item to a virtual shopping cart.

At 522, the nature of the interaction may include a database query using the configuration trigger details read at 520. Thus, for example, the SKU number may be used to query an inventory database residing at the back-end services. At 524, the information display portion of dynamic auxiliary user interface 100 is supplied with the interaction result between dynamic content engine 304 and the back-end services. For example, the inventory indicator may be provided with the looked-up inventory information as a result of the inventory query. At 526, the dynamic auxiliary user interface 100 is configured to display the informational and control elements that are specific to the primary display content, including, if applicable, any additionally-retrieved information from the back-end services which are associated with primary content 204.

Decision 528 determines whether there has been any user interaction with any control elements, such as text-entry fields, drop-down selectors, buttons, or the like. In the affirmative case, at 530, the received input is passed to the back-end services. For example, a transaction-building request may be provided to the back-end services based on input obtained from a user via a control element, such as operation of the “add to cart” button, with the transaction-building request in this example being the addition of the displayed item to a virtual shopping cart data structure residing at the back-end services.

At 532, an informational element of dynamic auxiliary user interface 100 may be added or updated in response to operation of the back-end services. For instance, a quantity-in-cart indicator may be added next to the “add to cart” button.

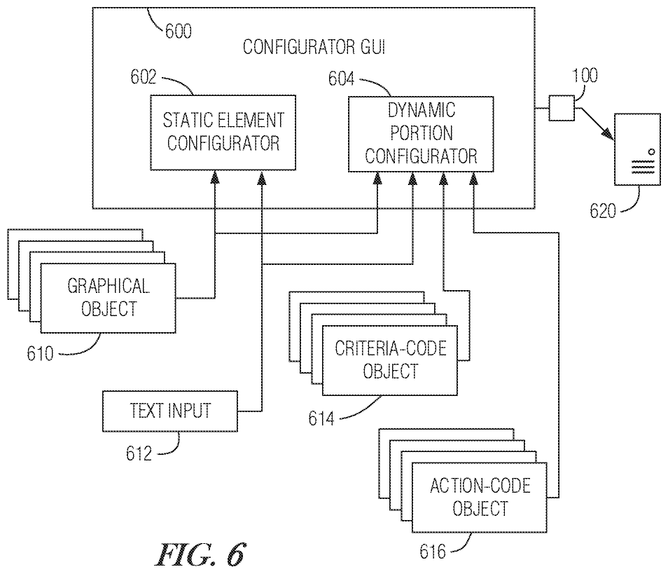

FIG. 6 is a block diagram illustrating a dynamic portion configurator graphical user interface (GUI) 600 according to an example embodiment. Dynamic portion configurator GUI 600 may be executed on a data-processing and computing platform that is the same, or different, than the data-processing and computing platform 220 on which dynamic auxiliary user interface 100 or primary user interface 202 are hosted.

Dynamic portion configurator GUI 600 includes static element configurator 602 and dynamic portion configurator 604. Each of these configurators includes user-interactive controls that facilitate selection and layout of various objects to be displayed in information display portion 102 (FIG. 1) or to be executed as part of control portion 104 (FIG. 1), for example.

The various objects may be selected from a set of static objects, such as graphical objects 610 (which may include animations or other media content), entry of text objects such as via text input 612. Static objects are those that are not conditionally displayed or autonomously-variable in their functionality.

The various objects may further include dynamic objects, such as ones selectable from a set of criteria-code objects 614 and a set of action-code objects 616. Criteria-code objects 614 include machine-executable code defining conditional and other logic that defines content, events, or various relationships thereof, the presence of which determines whether, or in what manner, the static objects are displayed, or whether, and in what manner, any actions are to be carried out in response to user input interactive with dynamic auxiliary user interface 100 or with primary user interface 202.

The set of action-code objects 616 include machine-executable code defining the actions to be carried out in response to user input interactive with dynamic auxiliary user interface 100 or with primary user interface 202.

When the user of GUI 600 completes configuration of one or more dynamic portions 108, and their layout in dynamic auxiliary user interface 100, dynamic auxiliary user interface 100 is output to server 620. Server 620 may be a web server, an advertisement server, a file server, or the like, as suitable for the greater system. Consistent with the above discussion, server 620 may be the same, or different, from a server or computing entity that hosts primary user interface 202, according to various embodiments. In one example, server 620 has the role of remote computing system 224.

As an example of a usage scenario for configurator GUI 600, in the context of e-commerce and advertisements where dynamic auxiliary user interface 100 is used to facilitate an advertisement with dynamic portions on a web page, graphical objects 610 may include items of artwork, logos, product images, announcements, or other advertising content. Text input 612 may be used to provide copy, or verbal content, for inclusion in the advertisement.

The dynamic portions may include such variable items as in-store pickup availability, stock quantity, add-to-cart or “buy-now” functionality, user ratings, loyalty-program sign-up, credit-application initiation. Criteria-code objects 614 may include such conditions as displaying the add-to-cart button only if stock is available, or displaying the user rating only if the user rating is 6-stars or better, for instance. Implementing such criteria may involve initiating queries in databases, and applying various decision logic, as discussed above. Action-code objects 616 in this example may include such actions as updating the user's shopping cart with the addition of the advertised item in response to an “add-to-cart” input from the user, arranging in-store pickup with the suitable store and generating corresponding user notification, or the like. These actions may include generating messaging or application program interface (API) calls to one or more engines of the e-commerce platform.

In a related embodiment, a dynamic portion 108 may be built and executed that is multi-step interactive with a user. For instance a dynamic portion may facilitate user selection of a local store via postal code or address input by the user.

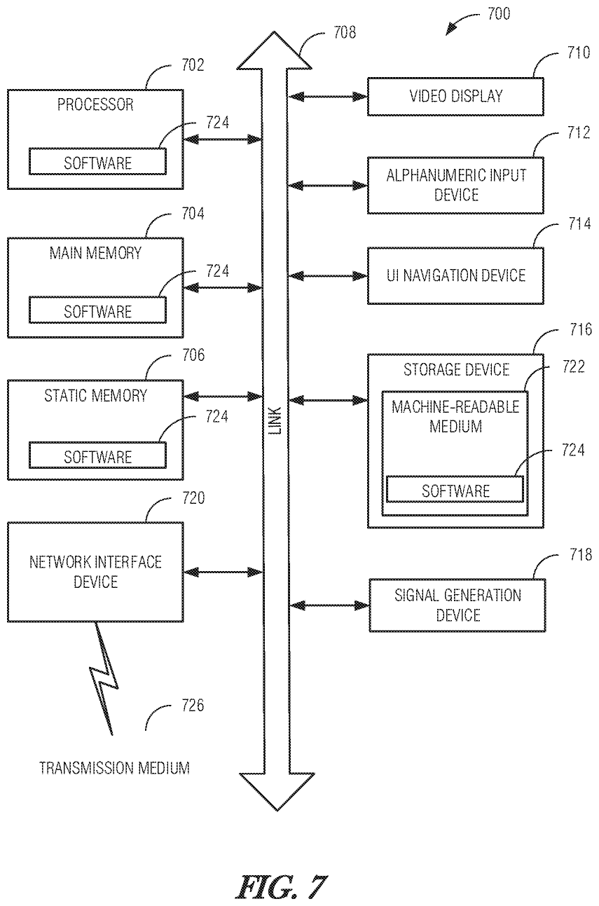

As an example of a suitable data-processing and computing platform on which aspects of the embodiments may be implemented or realized, FIG. 7 is a block diagram illustrating a computer system 700 in the form of a general-purpose machine, which may be incorporated as part of a stationary, mobile, or distributed-computing system. In certain embodiments, programming of the computer system 700 according to one or more particular algorithms produces a special-purpose machine upon execution of that programming. In a networked deployment, the computer system may operate in the capacity of either a server or a client machine in server-client network environments, or it may act as a peer machine in peer-to-peer (or distributed) network environments. As will be discussed in some examples below, a device may operate in a client mode or a server mode in alternating fashion, depending on whether it is an initiator, or responder, to a transaction or message.

Example computer system 700 includes at least one processor 702 (e.g., a central processing unit (CPU), a graphics processing unit (GPU) or both, processor cores, compute nodes, etc.), a main memory 704 and a static memory 706, which communicate with each other via a link 708 (e.g., bus). The computer system 700 may further include a video display unit 710, an input device 712 (e.g., an imaging sensor interface), and a user interface (UI) navigation device 714 (e.g., a mouse). The video display unit, according to various embodiments, may include a complex, user-interactive display, or a simple numerical or alpha-numerical display. In one embodiment, the video display unit 710, input device 712 and UI navigation device 714 are incorporated into a touch screen display. The computer system 700 may additionally include a storage device 716 (e.g., a drive unit), a signal generation device 718 (e.g., a speaker), a network interface device (NID) 720, and one or more sensors (not shown), such as a global positioning system (GPS) sensor, compass, accelerometer, or other sensor.

The storage device 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704, static memory 706, and/or within the processor 702 during execution thereof by the computer system 700, with the main memory 704, static memory 706, and the processor 702 also constituting machine-readable media.

While the machine-readable medium 722 is illustrated in an example embodiment to be a single medium, the term “machine-readable medium” may include a single medium or multiple media (e.g., a centralized or distributed database, and/or associated caches and servers) that store the one or more instructions 724. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

NID 720 according to various embodiments may take any suitable form factor. In one such embodiment, NID 720 is in the form of a network interface card (NIC) that interfaces with processor 702 via link 708. In one example, link 708 includes a PCI Express (PCIe) bus, including a slot into which the NIC form-factor may removably engage. In another embodiment, NID 720 is a network interface circuit laid out on a motherboard together with local link circuitry, processor interface circuitry, other input/output circuitry, memory circuitry, storage device and peripheral controller circuitry, and the like. In another embodiment, NID 720 is a peripheral that interfaces with link 708 via a peripheral input/output port such as a universal serial bus (USB) port. NID 720 transmits and receives data over transmission medium 726, which may be wired or wireless (e.g., radio frequency, infra-red or visible light spectra, etc.), fiber optics, or the like.

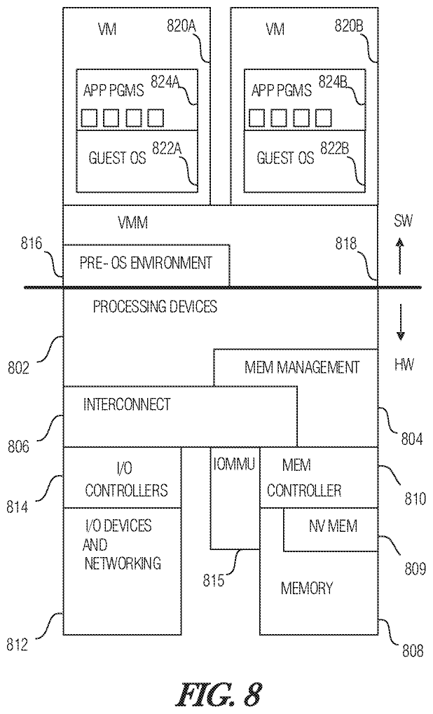

FIG. 8 is a diagram illustrating an exemplary hardware and software architecture of a computer system such as the one depicted in FIG. 7, in which various interfaces between hardware components and software components are shown. As indicated by HW, hardware components are represented below the divider line, whereas software components denoted by SW reside above the divider line. On the hardware side, processing devices 802 (which may include one or more microprocessors, digital signal processors, etc., each having one or more processor cores, are interfaced with memory management device 804 and system interconnect 806. Memory management device 804 provides mappings between virtual memory used by processes being executed, and the physical memory. Memory management device 804 may be an integral part of a central processing unit which also includes the processing devices 802.

Interconnect 806 includes a backplane such as memory, data, and control lines, as well as the interface with input/output devices, e.g., PCI, USB, etc. Memory 808 (e.g., dynamic random access memory—DRAM) and non-volatile memory 809 such as flash memory (e.g., electrically-erasable read-only memory—EEPROM, NAND Flash, NOR Flash, etc.) are interfaced with memory management device 804 and interconnect 806 via memory controller 810. I/O devices, including video and audio adapters, non-volatile storage, external peripheral links such as USB, Bluetooth, etc., camera/microphone data capture devices, fingerprint readers and other biometric sensors, as well as network interface devices such as those communicating via Wi-Fi or LTE-family interfaces, are collectively represented as I/O devices and networking 812, which interface with interconnect 806 via corresponding I/O controllers 814.

In a related embodiment, input/output memory management unit IOMMU 815 supports secure direct memory access (DMA) by peripherals. IOMMU 815 may provide memory protection by meditating access to memory 808 from I/O device 812. IOMMU 815 may also provide DMA memory protection in virtualized environments, where it allows certain hardware resources to be assigned to certain guest VMs running on the system, and enforces isolation between other VMs and peripherals not assigned to them.

On the software side, a pre-operating system (pre-OS) environment 816, which is executed at initial system start-up and is responsible for initiating the boot-up of the operating system. One traditional example of pre-OS environment 816 is a system basic input/output system (BIOS). In present-day systems, a unified extensible firmware interface (UEFI) is implemented. Pre-OS environment 816 is responsible for initiating the launching of the operating system or virtual machine manager, but also provides an execution environment for embedded applications according to certain aspects of the invention.

Virtual machine monitor (VMM) 818 is system software that creates and controls the execution of virtual machines (VMs) 820A and 820B. VMM 818 may run directly on the hardware HW, as depicted, or VMM 818 may run under the control of an operating system as a hosted VMM.

Each VM 820A, 820B includes a guest operating system 822A, 822B, and application programs 824A, 824B.

Each guest operating system (OS) 822A, 822B provides a kernel that operates via the resources provided by VMM 818 to control the hardware devices, manage memory access for programs in memory, coordinate tasks and facilitate multi-tasking, organize data to be stored, assign memory space and other resources, load program binary code into memory, initiate execution of the corresponding application program which then interacts with the user and with hardware devices, and detect and respond to various defined interrupts. Also, each guest OS 822A, 822B provides device drivers, and a variety of common services such as those that facilitate interfacing with peripherals and networking, that provide abstraction for corresponding application programs 824A, 824B so that the applications do not need to be responsible for handling the details of such common operations. Each guest OS 822A, 822B additionally may provide a graphical user interface (GUI) that facilitates interaction with the user via peripheral devices such as a monitor, keyboard, mouse, microphone, video camera, touchscreen, and the like. In some embodiments, guest OS 822B may omit a GUI.

Each guest OS 822A, 822B may provide a runtime system that implements portions of an execution model, including such operations as putting parameters onto the stack before a function call, the behavior of disk input/output (I/O), and parallel execution-related behaviors.

In addition, each guest OS 822A, 822B may provide libraries that include collections of program functions that provide further abstraction for application programs. These include shared libraries, dynamic linked libraries (DLLs), for example.

Application programs 824A, 824B are those programs that perform useful tasks for users, beyond the tasks performed by lower-level system programs that coordinate the basis operability of the computer system itself.

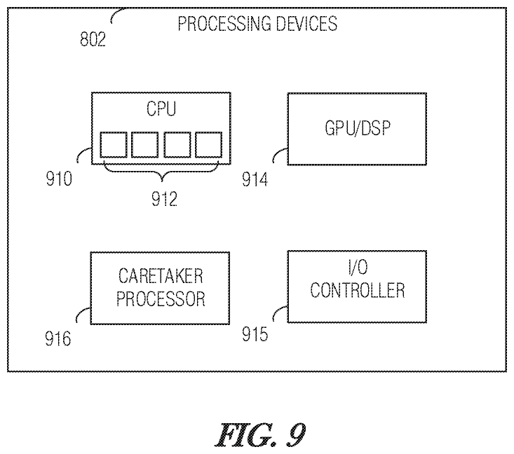

FIG. 9 is a block diagram illustrating processing devices 802 according to some embodiments. In one embodiment, two or more of processing devices 802 depicted are formed on a common semiconductor substrate. CPU 910 may contain one or more processing cores 912, each of which has one or more arithmetic logic units (ALU), instruction fetch unit, instruction decode unit, control unit, registers, data stack pointer, program counter, and other essential components according to the particular architecture of the processor. As an illustrative example, CPU 910 may be an x86-type of processor. Processing devices 802 may also include a graphics processing unit (GPU) 914. In these embodiments, GPU 914 may be a specialized co-processor that offloads certain computationally-intensive operations, particularly those associated with graphics rendering, from CPU 910. Notably, CPU 910 and GPU 914 generally work collaboratively, sharing access to memory resources, I/O channels, etc.

Processing devices 802 may also include caretaker processor 916 in some embodiments. Caretaker processor 916 generally does not participate in the processing work to carry out software code as CPU 910 and GPU 914 do. In some embodiments, caretaker processor 916 does not share memory space with CPU 910 and GPU 914, and is therefore not arranged to execute operating system or application programs. Instead, caretaker processor 916 may execute dedicated firmware that supports the technical workings of CPU 910, GPU 914, and other components of the computer system. In some embodiments, caretaker processor is implemented as a microcontroller device, which may be physically present on the same integrated circuit die as CPU 910, or may be present on a distinct integrated circuit die. Caretaker processor 916 may also include a dedicated set of I/O facilities to enable it to communicate with external entities. In one type of embodiment, caretaker processor 916 is implemented using a manageability engine (ME) or platform security processor (PSP). Input/output (I/O) controller 915 coordinates information flow between the various processing devices 910, 914, 916, as well as with external circuitry, such as a system interconnect.

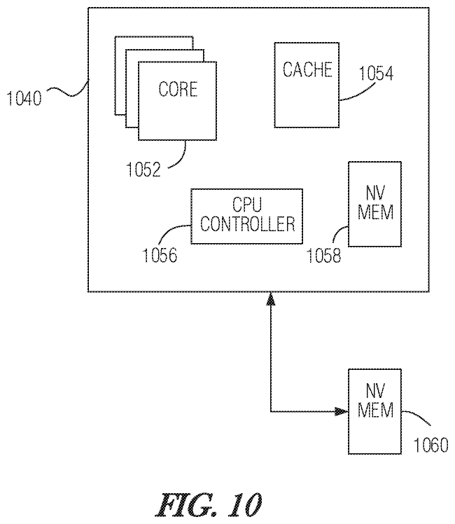

FIG. 10 is a block diagram illustrating example components of CPU 1040 according to various embodiments. As depicted, CPU 1040 includes one or more cores 1052, cache 1054, and CPU controller 1056, which coordinates interoperation and tasking of the core(s) 1052, as well as providing an interface to facilitate data flow between the various internal components of CPU 1040, and with external components such as a memory bus or system interconnect. In one embodiment, all of the example components of CPU 1040 are formed on a common semiconductor substrate.

CPU 1040 includes non-volatile memory 1058 (e.g., flash, EEPROM, etc.) for storing certain portions of foundational code, such as an initialization engine, and microcode. Also, CPU 1040 may be interfaced with an external (e.g., formed on a separate IC) non-volatile memory device 1060 that stores foundational code that is launched by the initialization engine, such as system BIOS or UEFI code.

### ADDITIONAL NOTES AND EXAMPLES

Example 1 is a user-interface apparatus for a computing system, comprising: computing hardware including at least one processing device, a display device, a communications device, and a user-input device, the processing hardware storing instructions that, when executed, cause the computing hardware to implement a primary user interface and a dynamic auxiliary user interface; wherein the primary user interface is operative to display primary content from a primary-content source on the display device, read user interaction with the primary content via the user-input device, and communicate with the primary-content source via the communications device based on the user interaction; and wherein the dynamic auxiliary user interface includes, an information display portion, a control portion, and a dynamic portion, wherein: the information display portion is operative to display supplemental information at least a part of which is dependent on the primary content, and to display a control element, wherein the supplemental information and the control element are viewable on the primary user interface, the control portion is operative to read user interaction with the control element via the user-input device and execute an action responsive to the user interaction with the control element; and the dynamic portion is operative to autonomously generate or vary the display of the supplemental information in response to the primary content, an attribute of the primary content, or the user interaction with the control element.

In Example 2, the subject matter of Example 1 includes, wherein the primary-content source is a computing entity that is remote from the computing system.

In Example 3, the subject matter of Examples 1-2 includes, wherein at least a portion of the supplemental information is provided by a supplemental-information source that is a computing entity distinct from the primary-content source.

In Example 4, the subject matter of Example 3 includes, wherein the supplemental-information source is remote from the computing system.

In Example 5, the subject matter of Examples 1-4 includes, wherein the dynamic portion is operative to communicate with the primary-content source via the communications device based on the user interaction with the control element.

In Example 6, the subject matter of Examples 1-5 includes, wherein the dynamic portion includes a sensor engine operative to read, as its input, at least a portion of the primary content or an attribute of the primary content, and to determine whether the input corresponds to configuration trigger criteria that defines a call for responsive action to be taken by the dynamic portion.

In Example 7, the subject matter of Example 6 includes, wherein the dynamic portion includes a dynamic content engine operative to generate or vary the supplemental information in response to a positive determination by the sensor engine of the input corresponding to the configuration trigger criteria or to the user interaction with the control element.

In Example 8, the subject matter of Examples 1-7 includes, wherein the primary user interface is part of a Web browser being executed by the computing system, wherein the primary-content source is a Web server, and wherein the attribute of the primary content comprises a uniform resource locator (URL) or Web address of the Web server.

In Example 9, the subject matter of Example 8 includes, wherein the primary content comprises an electronic-commerce Web page including a presentation of an item for sale; and wherein the supplemental information includes inventory information corresponding to the item for sale.

In Example 10, the subject matter of Example 9 includes, wherein the control element is a transaction-initiation control.

In Example 11, the subject matter of Examples 1-10 includes, wherein the primary user interface is part of an application program being executed by the computing system, and wherein the primary-content source is data associated with the application program.

In Example 12, the subject matter of Examples 1-11 includes, wherein the dynamic portion is operative to autonomously generate and vary the display of the supplemental information based on decision criteria, the user interaction, sensed circumstances, or any combination thereof.

Example 13 is a user-interface apparatus for a computing system, comprising: computing hardware including at least one processing device, a display device, a communications device, and a user-input device, the processing hardware storing instructions that, when executed, cause the computing hardware to implement a primary user interface and a dynamic auxiliary user interface; wherein the primary user interface is operative to display primary content from a primary-content source on the display device, read user interaction with the primary content via the user-input device, and communicate with the primary-content source via the communications device based on the user interaction; and wherein the dynamic auxiliary user interface includes, an information display portion and a dynamic portion, wherein: the information display portion is operative to display supplemental information to be viewable on the primary user interface, and including a first information portion and a second information portion, wherein the first information is received from a supplemental-information source that is a computing entity distinct from the user-interface apparatus, and wherein the second information portion is dependent on the primary content; the dynamic portion is operative to communicatively interact with the primary-content source to obtain additional supplemental information that is distinct from the primary content, and to generate or vary the display of the supplemental information, in response to the primary content or an attribute of the primary content.

In Example 14, the subject matter of Example 13 includes, wherein the primary-content source is a computing entity that is remote from the computing system.

In Example 15, the subject matter of Examples 13-14 includes, wherein the supplemental-information source is remote from the computing system.

In Example 16, the subject matter of Examples 13-15 includes, wherein the dynamic portion includes a sensor engine operative to read, as its input, at least a portion of the primary content or an attribute of the primary content, and to determine whether that input corresponds to configuration trigger criteria that defines a call for responsive action to be taken by the dynamic portion.

In Example 17, the subject matter of Example 16 includes, wherein the dynamic portion includes a dynamic content engine operative to generate or vary the supplemental information in response to a positive determination by the sensor engine of the input corresponding to the configuration trigger criteria.

In Example 18, the subject matter of Examples 13-17 includes, wherein the primary user interface is part of a Web browser being executed by the computing system, and wherein the primary-content source is a Web server.

In Example 19, the subject matter of Example 18 includes, wherein the primary content comprises an electronic-commerce Web page including a presentation of an item for sale; wherein the first information portion of the supplemental information includes a graphical object; and wherein the second information portion of the supplemental information includes inventory information corresponding to the item for sale.

In Example 20, the subject matter of Examples 13-19 includes, wherein the dynamic auxiliary user interface further includes a control portion operative to read user interaction with the control element via the user-input device and to execute an action responsive to the user interaction with the control element.

In Example 21, the subject matter of Example 20 includes, wherein the dynamic portion is operative to communicate with the primary-content source via the communications device based on the user interaction with the control element.

In Example 22, the subject matter of Examples 13-21 includes, wherein the primary user interface is part of an application program being executed by the computing system, and wherein the primary-content source is data associated with the application program.

In Example 23, the subject matter of Examples 13-22 includes, wherein the dynamic portion is operative to autonomously generate and vary the display of the supplemental information based on decision criteria, sensed circumstances, or any combination thereof.

Example 24 is a machine-implemented method for operating a user interface on a computing system, the method comprising: displaying, by a primary user interface of the computing system, primary content from a primary-content source on a display device; reading, by the primary user interface, user interaction with the primary content; communicating, by the primary user interface, with the primary-content source based on the user interaction; displaying, by an auxiliary dynamic user interface of the computing system, (a) supplemental information at least a part of which is dependent on the primary content, and (b) a control element, wherein the supplemental information and the control element are viewable on the primary user interface; reading, by the auxiliary dynamic user interface, user interaction with the control element; executing, by the auxiliary dynamic user interface, an action responsive to the user interaction with the control element; and by the auxiliary dynamic user interface, generating or varying the display of the supplemental information in response to the primary content, an attribute of the primary content, or the user interaction with the control element.

In Example 25, the subject matter of Example 24 includes, wherein the primary-content source is a computing entity that is remote from the computing system.

In Example 26, the subject matter of Examples 24-25 includes, wherein at least a portion of the supplemental information is provided by a supplemental-information source that is a computing entity distinct from the primary-content source.

In Example 27, the subject matter of Example 26 includes, wherein the supplemental-information source is remote from the computing system.

In Example 28, the subject matter of Examples 24-27 includes, communicating, by the auxiliary dynamic user interface, with the primary-content source based on the user interaction with the control element.

In Example 29, the subject matter of Examples 24-28 includes, reading as first input, by the auxiliary dynamic user interface, at least a portion of the primary content or an attribute of the primary content; and determining, by the auxiliary dynamic user interface, whether the first input corresponds to configuration trigger criteria that defines a call for responsive action to be taken.

In Example 30, the subject matter of Example 29 includes, wherein the generating or varying of the supplemental information is in response to a positive determination of the first input corresponding to the configuration trigger criteria or to the user interaction with the control element.

In Example 31, the subject matter of Examples 24-30 includes, wherein the primary user interface is part of a Web browser being executed by the computing system, wherein the primary-content source is a Web server, and wherein the attribute of the primary content comprises a uniform resource locator (URL) or Web address of the Web server.

In Example 32, the subject matter of Example 31 includes, wherein the primary content comprises an electronic-commerce Web page including a presentation of an item for sale; and wherein the supplemental information includes inventory information corresponding to the item for sale.

In Example 33, the subject matter of Example 32 includes, wherein the control element is a transaction-initiation control.

In Example 34, the subject matter of Examples 24-33 includes, wherein the primary user interface is part of an application program being executed by the computing system, and wherein the primary-content source is data associated with the application program.

In Example 35, the subject matter of Examples 24-34 includes, wherein the generating and varying of the display of the supplemental information is based on decision criteria, the user interaction, sensed circumstances, or any combination thereof.

Example 36 is a machine-implemented method for operating a user interface on a computing system, the method comprising: displaying, by a primary user interface of the computing system, primary content from a primary-content source on a display device; reading, by the primary user interface, user interaction with the primary content; communicating, by the primary user interface, with the primary-content source based on the user interaction; displaying, by an auxiliary dynamic user interface of the computing system, supplemental information at least a part of which is dependent on the primary content viewable on the primary user interface, the supplemental information including a first information portion and a second information portion, wherein the first information is received from a supplemental-information source that is a computing entity distinct from the computing system, and wherein the second information portion is dependent on the primary content; communicatively interacting, by the auxiliary dynamic user interface, with the primary-content source to obtain additional supplemental information that is distinct from the primary content; and generating or varying the display of the supplemental information, by the auxiliary dynamic user interface, in response to the primary content or an attribute of the primary content.

In Example 37, the subject matter of Example 36 includes, wherein the primary-content source is a computing entity that is remote from the computing system.

In Example 38, the subject matter of Examples 36-37 includes, wherein the supplemental-information source is remote from the computing system.

In Example 39, the subject matter of Examples 36-38 includes, reading as first input, by the auxiliary dynamic user interface, at least a portion of the primary content or an attribute of the primary content; and determining, by the auxiliary dynamic user interface, whether the first input corresponds to configuration trigger criteria that defines a call for responsive action to be taken.

In Example 40, the subject matter of Example 39 includes, wherein the generating or varying of the supplemental information is in response to a positive determination of the first input corresponding to the configuration trigger criteria or to the user interaction with the control element.

In Example 41, the subject matter of Examples 36-40 includes, wherein the primary user interface is part of a Web browser being executed by the computing system, and wherein the primary-content source is a Web server.

In Example 42, the subject matter of Example 41 includes, wherein the primary content comprises an electronic-commerce Web page including a presentation of an item for sale; wherein the first information portion of the supplemental information includes a graphical object; and wherein the second information portion of the supplemental information includes inventory information corresponding to the item for sale.

In Example 43, the subject matter of Examples 36-42 includes, displaying, by the auxiliary dynamic user interface, a control element viewable on the primary user interface; reading, by the auxiliary dynamic user interface, user interaction with the control element; and executing, by the auxiliary dynamic user interface, an action responsive to the user interaction with the control element.

In Example 44, the subject matter of Example 43 includes, communicating with the primary-content source, by the primary user interface, based on the user interaction with the control element.

In Example 45, the subject matter of Examples 36-44 includes, wherein the primary user interface is part of an application program being executed by the computing system, and wherein the primary-content source is data associated with the application program.

In Example 46, the subject matter of Examples 36-45 includes, wherein the generating and varying of the display of the supplemental information is based on decision criteria, the user interaction, sensed circumstances, or any combination thereof.

Example 47 is at least one non-transitory machine-readable storage medium comprising instructions that, when executed by a computing system, cause the computing system to: implement a primary user interface and a dynamic auxiliary user interface; wherein the primary user interface is operative to display primary content from a primary-content source on a display device, read user interaction with the primary content via a user-input device, and communicate with the primary-content source via the communications device based on the user interaction; and wherein the dynamic auxiliary user interface includes, an information display portion, a control portion, and a dynamic portion, wherein: the information display portion is operative to display supplemental information at least a part of which is dependent on the primary content, and to display a control element, wherein the supplemental information and the control element are viewable on the primary user interface; the control portion is operative to read user interaction with the control element via the user-input device and execute an action responsive to the user interaction with the control element; and the dynamic portion is operative to autonomously generate or vary the display of the supplemental information in response to the primary content, an attribute of the primary content, or the user interaction with the control element.

In Example 48, the subject matter of Example 47 includes, wherein the primary-content source is a computing entity that is remote from the computing system.

In Example 49, the subject matter of Examples 47-48 includes, wherein at least a portion of the supplemental information is provided by a supplemental-information source that is a computing entity distinct from the primary-content source.

In Example 50, the subject matter of Example 49 includes, wherein the supplemental-information source is remote from the computing system.

In Example 51, the subject matter of Examples 47-50 includes, wherein the dynamic portion is operative to communicate with the primary-content source via the communications device based on the user interaction with the control element.

In Example 52, the subject matter of Examples 47-51 includes, wherein the dynamic portion includes a sensor engine operative to read, as its input, at least a portion of the primary content or an attribute of the primary content, and to determine whether the input corresponds to configuration trigger criteria that defines a call for responsive action to be taken by the dynamic portion.

In Example 53, the subject matter of Example 52 includes, wherein the dynamic portion includes a dynamic content engine operative to generate or vary the supplemental information in response to a positive determination by the sensor engine of the input corresponding to the configuration trigger criteria or to the user interaction with the control element.

In Example 54, the subject matter of Examples 47-53 includes, wherein the primary user interface is part of a Web browser being executed by the computing system, wherein the primary-content source is a Web server, and wherein the attribute of the primary content comprises a uniform resource locator (URL) or Web address of the Web server.

In Example 55, the subject matter of Example 54 includes, wherein the primary content comprises an electronic-commerce Web page including a presentation of an item for sale; and wherein the supplemental information includes inventory information corresponding to the item for sale.

In Example 56, the subject matter of Example 55 includes, wherein the control element is a transaction-initiation control.

In Example 57, the subject matter of Examples 47-56 includes, wherein the primary user interface is part of an application program being executed by the computing system, and wherein the primary-content source is data associated with the application program.

In Example 58, the subject matter of Examples 47-57 includes, wherein the dynamic portion is operative to autonomously generate and vary the display of the supplemental information based on decision criteria, the user interaction, sensed circumstances, or any combination thereof.

Example 59 is at least one non-transitory machine-readable storage medium comprising instructions that, when executed by a computing system, cause the computing system to: implement a primary user interface and a dynamic auxiliary user interface; wherein the primary user interface is operative to display primary content from a primary-content source on the display device, read user interaction with the primary content via the user-input device, and communicate with the primary-content source via the communications device based on the user interaction; and wherein the dynamic auxiliary user interface includes, an information display portion and a dynamic portion, wherein: the information display portion is operative to display supplemental information to be viewable on the primary user interface, and including a first information portion and a second information portion, wherein the first information is received from a supplemental-information source that is a computing entity distinct from the user-interface apparatus, and wherein the second information portion is dependent on the primary content; the dynamic portion is operative to communicatively interact with the primary-content source to obtain additional supplemental information that is distinct from the primary content, and to generate or vary the display of the supplemental information, in response to the primary content or an attribute of the primary content.

In Example 60, the subject matter of Example 59 includes, wherein the primary-content source is a computing entity that is remote from the computing system.

In Example 61, the subject matter of Examples 59-60 includes, wherein the supplemental-information source is remote from the computing system.

In Example 62, the subject matter of Examples 59-61 includes, wherein the dynamic portion includes a sensor engine operative to read, as its input, at least a portion of the primary content or an attribute of the primary content, and to determine whether that input corresponds to configuration trigger criteria that defines a call for responsive action to be taken by the dynamic portion.

In Example 63, the subject matter of Example 62 includes, wherein the dynamic portion includes a dynamic content engine operative to generate or vary the supplemental information in response to a positive determination by the sensor engine of the input corresponding to the configuration trigger criteria.

In Example 64, the subject matter of Examples 59-63 includes, wherein the primary user interface is part of a Web browser being executed by the computing system, and wherein the primary-content source is a Web server.

In Example 65, the subject matter of Example 64 includes, wherein the primary content comprises an electronic-commerce Web page including a presentation of an item for sale; wherein the first information portion of the supplemental information includes a graphical object; and wherein the second information portion of the supplemental information includes inventory information corresponding to the item for sale.

In Example 66, the subject matter of Examples 59-65 includes, wherein the dynamic auxiliary user interface further includes a control portion operative to read user interaction with the control element via the user-input device and to execute an action responsive to the user interaction with the control element.

In Example 67, the subject matter of Example 66 includes, wherein the dynamic portion is operative to communicate with the primary-content source via the communications device based on the user interaction with the control element.

In Example 68, the subject matter of Examples 59-67 includes, wherein the primary user interface is part of an application program being executed by the computing system, and wherein the primary-content source is data associated with the application program.

In Example 69, the subject matter of Examples 59-68 includes, wherein the dynamic portion is operative to autonomously generate and vary the display of the supplemental information based on decision criteria, sensed circumstances, or any combination thereof.

Example 70 is at least one machine-readable medium including instructions that, when executed by processing circuitry, cause the processing circuitry to perform operations to implement of any of Examples 1-69.

Example 71 is an apparatus comprising means to implement of any of Examples 1-69.

Example 72 is a system to implement of any of Examples 1-69.

Example 73 is a method to implement of any of Examples 1-69.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A machine-implemented method for operating a user interface on a computing system, the method comprising:
displaying, by a primary user interface of the computing system, primary content from a primary-content source on a display device;
reading, by the primary user interface, user interaction with the primary content;
communicating, by the primary user interface, with the primary-content source based on the user interaction;
displaying, by an auxiliary dynamic user interface of the computing system, supplemental information at least a part of which is dependent on the primary content viewable on the primary user interface, the supplemental information including a first information portion and a second information portion, wherein the first information is received from a supplemental-information source that is a computing entity distinct from the computing system, and wherein the second information portion is dependent on the primary content;
communicatively interacting, by the auxiliary dynamic user interface, with the primary-content source to obtain additional supplemental information that is distinct from the primary content; and
generating or varying the display of the supplemental information, by the auxiliary dynamic user interface, in response to the primary content or an attribute of the primary content.

2. The method of claim 1, wherein the supplemental-information source is remote from the computing system.

3. The method of claim 1, further comprising:
reading as first input, by the auxiliary dynamic user interface, at least a portion of the primary content or an attribute of the primary content; and
determining, by the auxiliary dynamic user interface, whether the first input corresponds to configuration trigger criteria that defines a call for responsive action to be taken.

4. The method of claim 3, wherein the generating or varying of the supplemental information is in response to a positive determination of the first input corresponding to the configuration trigger criteria or to the user interaction with a control element.

5. The method of claim 1, wherein the primary user interface is part of a Web browser being executed by the computing system, and wherein the primary-content source is a Web server.

6. The method of claim 5, wherein the primary content comprises an electronic-commerce web page including a presentation of an item for sale;
wherein the first information portion of the supplemental information includes a graphical object; and
wherein the second information portion of the supplemental information includes inventory information corresponding to the item for sale.

7. At least one non-transitory machine-readable storage medium comprising instructions that, when executed by a computing system, cause the computing system to:
implement a primary user interface and a dynamic auxiliary user interface;
wherein the primary user interface is operative to display primary content from a primary-content source on a display device, read user interaction with the primary content via a user-input device, and communicate with the primary-content source via the communications device based on the user interaction; and
wherein the dynamic auxiliary user interface includes an information display portion, a control portion, and a dynamic portion, wherein:
the information display portion is operative to display supplemental information at least a part of which is dependent on the primary content, and to display a control element, wherein the supplemental information and the control element are viewable on the primary user interface;
the control portion is operative to read user interaction with the control element via the user-input device and execute an action responsive to the user interaction with the control element; and
the dynamic portion is operative to autonomously generate or vary the display of the supplemental information in response to the primary content, an attribute of the primary content, or the user interaction with the control element.

8. The at least one machine-readable medium of claim 7, wherein at least a portion of the supplemental information is provided by a supplemental-information source that is a computing entity distinct from the primary-content source.

9. The at least one machine-readable medium of claim 8, wherein the supplemental-information source is remote from the computing system.

10. The at least one machine-readable medium of claim 7, wherein the dynamic portion is operative to communicate with the primary-content source via the communications device based on the user interaction with the control element.

11. The at least one machine-readable medium of claim 7, wherein the primary user interface is part of a Web browser being executed by the computing system, wherein the primary-content source is a Web server, and wherein the attribute of the primary content comprises a uniform resource locator (URL) or Web address of the Web server.

12. The at least one machine-readable medium of claim 11, wherein the primary content comprises an electronic-commerce Web page including a presentation of an item for sale; and
wherein the supplemental information includes inventory information corresponding to the item for sale.

13. The at least one machine-readable medium of claim 12, wherein the control element is a transaction-initiation control.

14. A user-interface apparatus for a computing system, comprising:
computing hardware including at least one processing device, a display device, a communications device, and a user-input device, the processing device accessing instructions that, when executed, cause the computing hardware to implement a primary user interface and a dynamic auxiliary user interface;
wherein the primary user interface is operative to display primary content from a primary-content source on the display device, read user interaction with the primary content via the user-input device, and communicate with the primary-content source via the communications device based on the user interaction; and
wherein the dynamic auxiliary user interface includes an information display portion, a control portion, and a dynamic portion, wherein:
the information display portion is operative to display supplemental information at least a part of which is dependent on the primary content, and to display a control element, wherein the supplemental information and the control element are viewable on the primary user interface;
the control portion is operative to read user interaction with the control element via the user-input device and execute an action responsive to the user interaction with the control element; and
the dynamic portion is operative to autonomously generate or vary the display of the supplemental information in response to the primary content, an attribute of the primary content, or the user interaction with the control element.

15. The user-interface apparatus of claim 14, wherein the primary-content source is a computing entity that is remote from the computing system.

16. The user-interface apparatus of claim 14, wherein at least a portion of the supplemental information is provided by a supplemental-information source that is a computing entity distinct from the primary-content source.

17. The user-interface apparatus of claim 16, wherein the supplemental-information source is remote from the computing system.

18. The user-interface apparatus of claim 14, wherein the dynamic portion is operative to communicate with the primary-content source via the communications device based on the user interaction with the control element.

19. The user-interface apparatus of claim 14, wherein the dynamic portion includes a sensor engine operative to read, as its input, at least a portion of the primary content or an attribute of the primary content, and to determine whether the input corresponds to configuration trigger criteria that defines a call for responsive action to be taken by the dynamic portion.

20. The user-interface apparatus of claim 19, wherein the dynamic portion includes a dynamic content engine operative to generate or vary the supplemental information in response to a positive determination by the sensor engine of the input corresponding to the configuration trigger criteria or to the user interaction with the control element.
